(19) United States
(12) Patent Application Publication
(10) Pub. No.: US 2026/0132757 A1
(43) Pub. Date: May 14, 2026

(54) BURR-SHAPED CAST-IN CYLINDER LINER AND INSPECTION METHOD FOR SAME

(71) Applicant: ZYNP Corporation, Jiaozuo (CN)

(72) Inventors: Zengjun DANG, Jiaozuo (CN); Yahui XUE, Jiaozuo (CN); Wuhui ZOU, Jiaozuo (CN); Yong WANG, Jiaozuo (CN); Dong LIU, Jiaozuo (CN); Qifei HOU, Jiaozuo (CN); Guanghua ZHAO, Jiaozuo (CN)

(73) Assignee: ZYNP Corporation, Jiaozuo (CN)

(21) Appl. No.: 19/288,932

(22) Filed: Aug. 1, 2025

(30) Foreign Application Priority Data
Nov. 14, 2024 (CN) 2024116221239

(51) Int. Cl. F02F 7/00; B22D 19/00; B22D 19/08; B22D 46/00; F02F 1/00

(52) U.S. Cl. CPC F02F 7/0021; B22D 19/0009; B22D 19/08; B22D 46/00; F02F 1/004; F02F 7/0085; F02F 2200/06

(57) ABSTRACT

The present application relates to the fields of cylinder liners and inspection technologies thereof, and specifically, to a burr-shaped cast-in cylinder liner and an inspection method for same. The cylinder liner is made of cast iron and is cast into an engine block through a die casting or gravity casting process, and a plurality of burrs are formed on an outer circumferential surface of the cylinder liner. At least one of the burrs meets: in the burr-shaped cast-in cylinder liner, a diameter of the burr at a position 0.25 mm away from the top end is L₁, a diameter of the burr at a position 0.4 mm away from the top end is L₂, and a range of a ratio of the diameter L₁ to the diameter L₂ is 0.65≤L₁:L₂≤1.15. The specific shape of a burr is defined by defining diameter sizes of the burr at two special positions away from the top end, to ensure the bonding ratio between a single burr and an engine block and the bonding ratio between a liner and the engine block, thereby ensuring good heat dissipation performance between the liner and the engine block and ensuring no deformation in the operation process of the liner.

### RELATED APPLICATIONS

This application claims priority to Chinese Patent Application No. 2024116221239, filed Nov. 14, 2024, entitled Burr-Shaped Cast-In Cylinder Liner And Inspection Method For Same, which is hereby incorporated herein by reference in its entirety.

### TECHNICAL FIELD

The present application relates to the fields of cylinder liners and inspection technologies thereof, and specifically, to a burr-shaped cast-in cylinder liner and an inspection method for same.

### BACKGROUND ART

A cast-in cylinder liner is a cylindrical component cast into an engine block. During the operation of an internal combustion engine, the inner surface of the cylinder liner is directly exposed to high-temperature, high-pressure combustion gases and continuously undergoes high-speed sliding friction against the piston rings and piston skirt. Therefore, the cylinder liner must be securely integrated with the engine block to prevent displacement while transferring heat from the liner surface to the engine block to ensure that the liner maintains an optimal temperature. This requires both strong bonding strength and excellent heat dissipation performance between the liner and the engine block.

In the related art, to enhance the bonding strength between the cylinder liner and the engine block, raised structures, namely, burrs, are typically formed on the surface of the cylinder liner. These burrs exhibit various shapes, including dumbbell-shaped, columnar, spike-shaped, eagle-beak-shaped, interconnected-spike-shaped, or worm-like configurations, with dumbbell-shaped and spike-shaped configurations being predominant. The specific shape, size, and other characteristics of the burrs influence the bonding ratio between the cylinder liner and the engine block. Since the bonding ratio between the cylinder liner and the engine block significantly impacts the effective heat dissipation of the liner, increasing the bonding ratio between individual burrs and the engine block to increase the bonding ratio between the liner and the engine block can substantially improve the heat dissipation of the liner. Consequently, those skilled in the art need to investigate how burrs of different shapes effectively improve the bonding ratio between the liner and the engine block.

### SUMMARY

Therefore, the technical problem to be solved by the present application is that the bonding ratio between a single burr and an engine block is insufficient, and the bonding ratio between a liner and the engine block is insufficient, resulting in suboptimal heat dissipation of the liner in the related art. For this, the present application provides a burr-shaped cast-in cylinder liner, the cylinder liner being made of cast iron and being cast into an engine block through a die casting or gravity casting process, and a plurality of burrs being formed on an outer circumferential surface of the cylinder liner, where at least one of the burrs meets:
a diameter of the burr at a position 0.25 mm away from the top end is L₁, a diameter of the burr at a position 0.4 mm away from the top end is L₂, and a range of a ratio of the diameter L₁ to the diameter L₂ is 0.65≤L₁:L₂≤1.15, where
the burr includes a necked-shaped protrusion, and a position of the protrusion that is within an interval of 0.2 mm to 0.35 mm away from the top end of the burr is a necked structure; or the burr includes a tapered protrusion.

In the foregoing structure, optionally, the necked-shaped protrusion is a dumbbell-shaped burr;
a point A₁ and a point A₃ are provided on an outer contour of the dumbbell-shaped burr at the position of the diameter L₁ of the dumbbell-shaped burr, a connecting line between the point A₁ and the point A₃ is the diameter L₁, a point A₂ is further provided at the apex of an outer contour of a dumbbell-shaped protrusion position of the dumbbell-shaped burr, the point A₂ and the point A₁ are located in the same longitudinal section of the dumbbell-shaped burr, a connecting line between the point A₁ and the point A₂ is a connecting line A₁A₂, the connecting line between the point A₁ and the point A₃ is a connecting line A₁A₃, and an included angle between an extension of the connecting line A₁A₃ and the connecting line A₁A₂ is α2;
a point A₄ and a point A₅ are provided at the outer contour of the dumbbell-shaped burr at the position of the diameter L₂ of the dumbbell-shaped burr, a connecting line between the point A₄ and the point A₅ is the diameter L₂, the point A₄ and the point A₁ are located in the same longitudinal section of the dumbbell-shaped burr, a connecting line between the point A₄ and the point A₁ is a connecting line A₄A₁, the connecting line between the point A₄ and the point A₅ is a connecting line A₄A₅, and an included angle between the connecting line A₄A₁ and the connecting line A₄A₅ is α1; and
a range of a ratio of α1 to α2 is α1:α2≥0.5.

In the foregoing structure, optionally, the range of the ratio of α1 to α2 is α1:α2≤2.1.

In the foregoing structure, optionally, on the cylinder liner, the number of the dumbbell-shaped burrs within the range of 1 square centimeter ranges from 30 to 80.

In the foregoing structure, optionally, the number of the dumbbell-shaped burrs through which any 10-mm-long line segment of the outer circumferential surface of the cylinder liner passes is 4 to 8.

In the foregoing structure, optionally, the tapered protrusion is a conical burr;
a point A₁ and a point A₃ are provided on an outer contour of the conical burr at the position of the diameter L₁ of the conical burr, a connecting line between the point A₁ and the point A₃ is the diameter L₁, a point A₂ is further provided on the outer contour of the conical burr, the point A₂ is located at a position 0.1 mm away from the top end of the burr, the point A₂ and the point A₁ are located in the same longitudinal section of the conical burr, a connecting line between the point A₁ and the point A₂ is a connecting line A₁A₂, the connecting line between the point A₁ and the point A₃ is a connecting line A₁A₃, and an included angle between the connecting line A₁A₃ and the connecting line A₁A₂ is α2;
a point A₄ and a point A₅ are provided at the outer contour of the conical burr at the position of the diameter L₂ of the conical burr, a connecting line between the point A₄ and the point A₅ is the diameter L₂, the point A₄ and the point A₁ are located in the same longitudinal section of the conical burr, a connecting line between the point A₄ and the point A₁ is a connecting line A₄A₁, the connecting line between the point A₄ and the point A₅ is a connecting line A₄A₅, and an included angle between the connecting line A₄A₁ and the connecting line A₄A₅ is α1; and
a range of a ratio of α1 to α2 is α1:α2≥0.25.

In the foregoing structure, optionally, the range of the ratio of α1 to α2 is α1:α2≤1.0.

In the foregoing structure, optionally, on the cylinder liner, the number of the conical burrs within the range of 1 square centimeter ranges from 45 to 85.

In the foregoing structure, optionally, the number of the conical burrs through which any 10-mm-long line segment of the outer circumferential surface of the cylinder liner passes is 6 to 11.

A burr inspection method for a burr-shaped cast-in cylinder liner includes:
a method for inspecting the values of diameters of a burr at positions 0.25 mm and 0.4 mm away from the top end of the burr, including the following steps:
step S101. using an end position of a cylinder liner or a vertical sectioned surface of the cylinder liner in a radial direction as an inspection surface;
step S102. placing the inspection surface of the cylinder liner under an objective lens of an ultra-depth-of-field microscope;
step S103. rotating a coarse focus knob and a fine focus knob until a clear image is displayed on a computer screen;
step S104. finding the positions of the burr that are 0.25 mm and 0.4 mm away from the top end on the image in step S103 downward from the top end of the burr in a vertical direction, where the highest point of a burr longitudinal section is selected for the position of the burr away from the top end, and an allowable deviation for a distance of the burr that is away from the top end is ±0.018 mm; and
step S105. inspecting the value of an intercept L₁ of the position of the burr that is 0.25 mm away from the top end and the value of an intercept L₂ at the position of the burr that is 0.4 mm away from the top end in step S104, where the diameters of the burr at the positions 0.25 mm and 0.4 mm away from the top end are horizontal direction lengths of the burr longitudinal section.

In the foregoing burr inspection method, optionally, the burr inspection method is applied to the foregoing burr-shaped cast-in cylinder liner.

In the foregoing burr inspection method, optionally, the burr inspection method is applied to the inspection of an included angle α1 and an included angle α2 of the dumbbell-shaped burr in the burr-shaped cast-in cylinder liner;
an inspection method for the included angle α1 and the included angle α2 of the dumbbell-shaped burr is:
step S201. finding the positions of the dumbbell-shaped burr that are 0.25 mm and 0.4 mm away from the top end according to step S101 to step S104; and
step S202. selecting the point A₁ and the point A₃ on the outer contour of the dumbbell-shaped burr at the position of the burr that is 0.25 mm away from the top end in step S201, selecting the point A₂ at the apex of the outer contour of the dumbbell-shaped protrusion position of the dumbbell-shaped burr, where the point A₂ is the outermost side position of the dumbbell-shaped protrusion of the burr longitudinal section on the image of the ultra-depth-of-field microscope in step S103, and an allowable deviation for the outermost side position of the dumbbell-shaped protrusion is ±0.018 mm, measuring the included angle α2 between the extension of the connecting line A₁A₃ and the connecting line A₁A₂ through a software angle measurement function of the ultra-depth-of-field microscope,
selecting the point A₄ and the point A₅ on the outer contour of the dumbbell-shaped burr at the position of the burr that is 0.4 mm away from the top end in step S201, and measuring the included angle α1 between the connecting line A₄A₁ and the connecting line A₄A₅ through the software angle measurement function of the ultra-depth-of-field microscope.

In the foregoing burr inspection method, optionally, the burr inspection method is applied to the inspection of an included angle α1 and an included angle α2 of the conical burr in the burr-shaped cast-in cylinder liner;
an inspection method for the included angle α1 and the included angle α2 of the conical burr is:
step S301. finding the positions of the conical burr that are 0.25 mm and 0.4 mm away from the top end according to step S101 to step S104; and
step S302. selecting the point A₁ and the point A₃ on the outer contour of the conical burr at the position of the burr that is 0.25 mm away from the top end in step S301, finding a position of the burr that is 0.1 mm away from the top end on the image of the ultra-depth-of-field microscope in step S103 downward from the top end of the burr in the vertical direction, selecting the point A₂ on the outer contour of the burr longitudinal section on the image of the ultra-depth-of-field microscope at the position of the burr that is 0.1 mm away from the top end, measuring the included angle α2 between the extension of the connecting line A₁A₃ and the connecting line A₁A₂ through a software angle measurement function of the ultra-depth-of-field microscope,
selecting the point A₄ and the point A₅ on the outer contour of the conical burr at the position of the burr that is 0.4 mm away from the top end in step S301, and measuring the included angle α1 between the connecting line A₄A₁ and the connecting line A₄A₅ through the software angle measurement function of the ultra-depth-of-field microscope.

In this embodiment, a bonding ratio measurement method specifically includes the following steps:
step S1. die-casting a liner in an engine block, controlling a molten aluminum smelting temperature within a range of 700° C. to 720° C., and controlling a pouring temperature within a range of 650° C. to 680° C.; controlling a pre-heating temperature of the liner within 130° C. to 150° C., using a 28,000 KN die-casting machine, and setting a slow shot speed to 0.2 m/s and a fast shot speed to 5.5 m/s; and setting and maintaining a final pressure at 45 MPa;
step S2. cutting a circumferential section from the die-cast engine block at a position 25 mm to 35 mm away from a liner top end, and cutting a circumferential section from the die-cast engine block at a position 25 mm to 35 mm away from a liner bottom end; and
subsequently, grinding the foregoing annular end surfaces at the liner top end and the liner bottom end using sandpaper, sequentially with 180-grit, 400-grit, and 800-grit water sandpaper, and polishing the end surfaces on a polishing machine as required;
step S3. inspecting the bonding ratio between the aluminum engine block and the liner outer diameter for the liner top end and the liner bottom end of the ground and polished liner, where specific inspection positions are: as shown in FIG. 6, four liner outer diameter positions A with a perimeter of 10 mm at positions at 90-degree intervals of the liner outer diameter, and a specific inspection method is:
step S301. measuring a length of a pore with a perimeter below 10,000 μm along the surface of a burr through an ultra-depth-of-field microscope, where a gap between the aluminum engine block and the cast iron of the cylinder liner observed through visual inspection under the microscope is a pore at the position; and the measured length of the gap is the length of the pore; and
step S302. calculating the foregoing bonding ratio between the aluminum engine block and the liner outer diameter by using a bonding ratio calculation formula: Bonding Ratio=(100−(ΣPorosity Length²/100,000,000))%, where the length of the pore is measured in μm.

The technical solution in the present application has the following advantages:

1. For the burr-shaped cast-in cylinder liner provided in the present application, the plurality of burrs are formed on the outer circumferential surface of the cylinder liner. The diameter of the burr at the position 0.25 mm away from the top end is defined as L₁, the diameter of the burr at the position 0.4 mm away from the top end is defined as L₂, and the range of the ratio of the diameter L₁ to the diameter L₂ above is defined as 0.65≤L₁:L₂≤1.15.

The position of the necked-shaped protrusion that is within the interval of 0.2 mm to 0.35 mm away from the top end of the burr is the necked structure. Therefore, the position 0.25 mm away from the top end of the burr falls within the necked range of the dumbbell-shaped burr. In addition, the position 0.4 mm away from the top end of the burr is the position of an outer circumferential surface of the burr close to the cylinder liner. The position influences the bonding strength between the burr and the cylinder liner and the geometric characteristics of the burr. In the present application, the range of the ratio of the diameter L₁ to the diameter L₂ is defined as 0.65≤L₁:L₂≤1.15. Within the foregoing range of the ratio, the dumbbell-shaped burr is a necked-shaped protrusion, and the conical burr is a tapered protrusion. In the foregoing two burrs, the bonding ratio between a single burr and the engine block is high, to improve the bonding ratio between the liner and the engine block, thereby ensuring the overall structure of the liner and the heat transfer capability of the engine block, and ensuring that the liner has an excellent heat dissipation capability.

2. For the burr-shaped cast-in cylinder liner provided in the present application, the point A₁ and the point A₃ are provided on the outer contour of the dumbbell-shaped burr at the position of the diameter L₁ of the dumbbell-shaped burr, the connecting line between the point A₁ and the point A₃ is the diameter L₁, the point A₂ is further provided at the apex of the outer contour of the dumbbell-shaped protrusion position of the dumbbell-shaped burr, the point A₂ and the point A₁ are located in the same longitudinal section of the dumbbell-shaped burr, the connecting line between the point A₁ and the point A₂ is the connecting line A₁A₂, the connecting line between the point A₁ and the point A₃ is the connecting line A₁A₃, and the included angle between the extension of the connecting line A₁A₃ and the connecting line A₁A₂ is α2.

The point A₄ and the point A₅ are provided at the outer contour of the dumbbell-shaped burr at the position of the diameter L₂ of the dumbbell-shaped burr, the connecting line between the point A₄ and the point A₅ is the diameter L₂, the point A₄ and the point A₁ are located in the same longitudinal section of the dumbbell-shaped burr, the connecting line between the point A₄ and the point A₁ is the connecting line A₄A₁, the connecting line between the point A₄ and the point A₅ is the connecting line A₄A₅, and the included angle between the connecting line A₄A₁ and the connecting line A₄A₅ is α1.

The foregoing range of the ratio of α1 to α2 is α1:α2≥0.5.

The foregoing point A₂ and point A₁ are located on the same sectioned surface of the image of the ultra-depth-of-field microscope, so that it can be effectively ensured that the foregoing point A₂ and point A₁ are located on the same vertical direction plane of the dumbbell-shaped burr. The foregoing point A₄ and point A₁ are located on the same sectioned surface of the image of the ultra-depth-of-field microscope, so that it can be effectively ensured that the foregoing point A₄ and point A₁ are located on the same vertical direction plane of the dumbbell-shaped burr.

Under the foregoing conditions, when the value of α1 is smaller, the position of the outer circumferential surface of the dumbbell-shaped burr close to the cylinder liner, that is, the middle-to-lower position of the dumbbell-shaped burr, tends to flatten progressively. When the middle-to-lower position of the dumbbell-shaped burr tends to flatten, the connecting surface between the dumbbell-shaped burr and the outer circumferential surface of the cylinder liner is increased. The dumbbell-shaped burr and the outer circumferential surface of the cylinder liner are securely connected and not prone to fracturing. Certainly, if the value of α1 is excessively large, the bottom of the dumbbell-shaped burr on the cylinder liner has a large inverted cone. During shot blasting of coatings, residues such as coatings tend to accumulate at the neck and root of the burr. As a result, during the die casting of the liner, inclusions and gas pores tend to form on a bonding surface between the root of the burr and the aluminum engine block, causing the problem of a decrease in the bonding ratio between the liner and the engine block.

Under the foregoing conditions, α2 defines the structure of the necked position of the dumbbell-shaped burr. When α2 falls within a suitable range, the bonding ratio between a single burr and the engine block is high, and the bonding ratio between the liner and the engine block is high, thereby ensuring that the overall structure of the liner has an excellent heat dissipation capability.

In addition, the present application further defines that the range of the ratio of α1 to α2 in the dumbbell-shaped burr is α1:α2>0.5. When the foregoing α1 and α2 fall within the foregoing range of the ratio, the bonding ratio between each burr and the engine block is high, and the bonding ratio between the liner and the engine block is high, thereby ensuring that the liner has an excellent heat dissipation capability.

3. For the burr-shaped cast-in cylinder liner provided in the present application, the present application further defines that the range of the ratio of α1 to α2 in the dumbbell-shaped burr is 0.5≤α1:α2≤2.1. When the foregoing α1 and α2 fall within the foregoing range of the ratio, it can be effectively ensured that the bonding ratio between each burr and the engine block is high, thereby ensuring that the overall structure of the liner has an excellent heat dissipation capability.

4. For the burr-shaped cast-in cylinder liner provided in the present application, on the cylinder liner, the number of the dumbbell-shaped burrs within the range of 1 square centimeter ranges from 30 to 80.

In the present application, the number of the dumbbell-shaped burrs within the range of 1 square centimeter ranges from 30 to 80, and further optionally, ranges from 30 to 55. When the number of dumbbell-shaped burrs is suitable, the bonding ratio between the outer surface of the liner and the engine block can be ensured. An increase in the bonding ratio can effectively ensure the heat dissipation capability of the overall structure of the liner, and also improve the bonding strength between the overall structure of the cylinder liner and the engine block.

5. For the burr-shaped cast-in cylinder liner provided in the present application, the number of the dumbbell-shaped burrs through which any 10-mm-long line segment of the outer circumferential surface of the cylinder liner with the dumbbell-shaped burrs on the surface passes is 4 to 8.

The number of the dumbbell-shaped burrs through which any 10-mm-long line segment of the outer circumferential surface of the cylinder liner passes is defined, so that the burr density of the dumbbell-shaped burrs on the outer circumferential surface of the cylinder liner can be effectively defined. When the density of dumbbell-shaped burrs is suitable, the bonding ratio between the outer surface of the liner and the engine block can be ensured. An increase in the bonding ratio can effectively ensure the heat dissipation capability of the overall structure of the liner, and also improve the bonding strength between the overall structure of the cylinder liner and the engine block.

6. For the burr-shaped cast-in cylinder liner provided in the present application, the point A₁ and the point A₃ are provided on the outer contour of the conical burr at the position of the diameter L₁ of the conical burr, the point A₁ and the point A₃ are located at the position 0.25 mm away from the top end of the burr, the connecting line between the point A₁ and the point A₃ is the diameter L₁, the point A₂ is further provided on the outer contour of the conical burr, the point A₂ is located at the position 0.1 mm away from the top end of the burr, the point A₂ and the point A₁ are located in the same longitudinal section of the dumbbell-shaped burr, the connecting line between the point A₁ and the point A₂ is the connecting line A₁A₂, the connecting line between the point A₁ and the point A₃ is the connecting line A₁A₃, and the included angle between the connecting line A₁A₃ and the connecting line A₁A₂ is α2.

The point A₄ and the point A₅ are provided at the outer contour of the conical burr at the position of the diameter L₂ of the conical burr, the connecting line between the point A₄ and the point A₅ is the diameter L₂, the point A₄ and the point A₅ are located at the position 0.4 mm away from the top end of the burr, the point A₄ and the point A₁ are located in the same longitudinal section of the conical burr, the connecting line between the point A₄ and the point A₁ is the connecting line A₄A₁, the connecting line between the point A₄ and the point A₅ is the connecting line A₄A₅, and the included angle between the connecting line A₄A₁ and the connecting line A₄A₅ is α1.

The range of the ratio of α1 to α2 is α1:α2≥0.25.

The foregoing point A₂ and point A₁ are located on the same sectioned surface of the image of the ultra-depth-of-field microscope, so that it can be effectively ensured that the foregoing point A₂ and point A₁ are located on the same vertical direction plane of the conical burr. The foregoing point A₄ and point A₁ are located on the same sectioned surface of the ultra-depth-of-field microscope, so that it can be effectively ensured that the foregoing point A₄ and point A₁ are located on the same vertical direction plane of the conical burr.

The point A₂ is selected as the position 0.1 mm away from the top end of the burr because the connecting line A₁A₂ is closer to the form of a conical burr. In addition, the position 0.1 mm away from the top end of the burr is far away from the planar position of the top end of the burr, and is hardly susceptible to the sudden flattening of the form of the top end of the conical burr.

Under the foregoing conditions, when the value of α1 is larger, the position of the outer circumferential surface of the conical burr close to the cylinder liner, that is, the middle-to-lower position of the conical burr, tends to flatten progressively. When the middle-to-lower position of the conical burr tends to flatten, the connecting surface between the conical burr and the outer circumferential surface of the cylinder liner is increased. The conical burr and the outer circumferential surface of the cylinder liner are securely connected and not prone to fracturing. Certainly, if the value of α1 is excessively large, the conical burr on the cylinder liner exhibits a large inverted conical shape. During shot blasting, it is not easy to clear coatings at the root of the burr, and the root of the burr is prone to defects such as inclusions and gas pores during die casting, resulting in the problem of a reduced bonding ratio.

Under the foregoing conditions, α2 defines the structure of the necked position of the conical burr. When α2 falls within a suitable range, the bonding ratio between a single burr and the engine block is high, and the bonding ratio between the engine block and the outer surface of the liner is also high, thereby ensuring that the overall structure of the liner has an excellent heat dissipation capability.

In addition, the present application further defines that the range of the ratio of α1 to α2 is α1:α2>0.25. When the foregoing α1 and α2 fall within the foregoing range of the ratio, the bonding ratio between the liner and the engine block is high, thereby ensuring that the overall structure of the liner has an excellent heat dissipation capability.

7. For the burr-shaped cast-in cylinder liner provided in the present application, the present application further defines that the range of the ratio of α1 to α2 in the conical burr is 0.25≤α1:α2≤1.0. When the foregoing α1 and α2 fall within the foregoing range of the ratio, it can be effectively ensured that the bonding ratio between each burr and the engine block is high, thereby ensuring that the overall structure of the liner has an excellent heat dissipation capability.

8. For the burr-shaped cast-in cylinder liner provided in the present application, on the cylinder liner, the number of the conical burrs within the range of 1 square centimeter ranges from 45 to 85.

In the present application, the number of the conical burrs within the range of 1 square centimeter ranges from 45 to 85. When the number of conical burrs is suitable, the bonding ratio between the outer surface of the liner and the engine block can be ensured. An increase in the bonding ratio can effectively ensure the heat dissipation capability of the overall structure of the liner, and also improve the bonding strength between the overall structure of the cylinder liner and the engine block.

9. For the burr-shaped cast-in cylinder liner provided in the present application, the number of the conical burrs through which any 10-mm-long line segment of the outer circumferential surface of the cylinder liner passes is 6 to 11.

The number of the conical burrs through which any 10-mm-long line segment of the outer circumferential surface of the cylinder liner passes is defined, so that the number and the burr density of the conical burrs on the outer circumferential surface of the cylinder liner can be effectively defined. Under the foregoing parameters, when the density of conical burrs is suitable, the bonding ratio between the outer surface of the liner and the engine block can be ensured. An increase in the bonding ratio can effectively ensure the heat dissipation capability of the overall structure of the liner, and also improve the bonding strength between the overall structure of the cylinder liner and the engine block.

10. The burr inspection method for a burr-shaped cast-in cylinder liner provided in the present application includes: a method for inspecting the values of diameters of a burr at positions 0.25 mm and 0.4 mm away from the top end of the burr, specifically including the following steps:

Step S101. Use the end position of the cylinder liner or the vertical sectioned surface of the cylinder liner in the radial direction as the inspection surface. In this step, the end position of the cylinder liner or the radial sectioned surface of the cylinder liner is used as the inspection surface, so that the inspection surface can be simply and easily found. In addition, in the present application, the specific position of the radial sectioned surface of the cylinder liner is not limited.

Step S102. Place the inspection surface of the cylinder liner under the objective lens of the ultra-depth-of-field microscope. Step S103. Rotate the coarse focus knob and the fine focus knob until the clear image is displayed on the computer screen. In this step, the ultra-depth-of-field microscope is focused on the image of the inspection surface. In addition, for the specific selection of burr under inspection, a burr that has been cut to expose a relatively complete longitudinal section is selected. The “relatively complete” means a burr longitudinal section formed through cutting along the longitudinal section from the position close to the top of the burr.

Step S104. Find the positions of the burr that are 0.25 mm and 0.4 mm away from the top end on the image in step S103 downward from the top end of the burr in the vertical direction, where the highest point of the burr longitudinal section is selected for the position of the burr away from the top end, and the allowable deviation for the distance of the burr that is away from the top end is ±0.018 mm. In the foregoing step, the positions of the chosen burr to be inspected 0.25 mm and 0.4 mm away from the top end in the burr in the image in step S103 are found. A specific method is finding the positions of the burr 0.25 mm and 0.4 mm away from the top end by using the vertical line marking function of an ultra-depth-of-field microscope device. In this step, the highest point of the burr longitudinal section is selected for the position of the burr away from the top end, and the allowable deviation for the distance of the burr that is away from the top end is ±0.018 mm, thereby reducing the impact of human factors.

Step S105. Inspect the value of an intercept L₁ of the position of the burr that is 0.25 mm away from the top end and the value of the intercept L₂ at the position of the burr that is 0.4 mm away from the top end in step S104, where the diameters of the burr at the positions 0.25 mm and 0.4 mm away from the top end are the horizontal direction lengths of the burr longitudinal section. In this step, the values of the horizontal direction lengths at the foregoing positions at 0.25 mm and 0.4 mm are separately measured by using the horizontal line marking function of the ultra-depth-of-field microscope device.

11. For the burr inspection method for a burr-shaped cast-in cylinder liner provided in the present application, the inspection method for the included angle α1 and the included angle α2 of the dumbbell-shaped burr is:

Step S201. Find the positions of the dumbbell-shaped burr that are 0.25 mm and 0.4 mm away from the top end according to step S101 to step S104. In this step, the measurement method that is the same as that in step S101 to step S104 is used to find the positions of the dumbbell-shaped burr that are 0.25 mm and 0.4 mm away from the top end.

Step S202. Select the point A₁ and the point A₃ on the outer contour of the dumbbell-shaped burr at the position of the burr that is 0.25 mm away from the top end in step S201, select the point A₂ at the apex of the outer contour of the dumbbell-shaped protrusion position of the dumbbell-shaped burr, where the point A₂ is the outermost side position of the dumbbell-shaped protrusion of the burr longitudinal section on the image of the ultra-depth-of-field microscope in step S103, and measure the included angle α2 between the extension of the connecting line A₁A₃ and the connecting line A₁A₂ through the software angle measurement function of the ultra-depth-of-field microscope. In this step, for the position selection of the point A₁ and the point A₃ on the outer contour of the dumbbell-shaped burr, based on the position of the burr 0.25 mm away from the top end found in step S201 and by using the horizontal line marking function of the ultra-depth-of-field microscope device, points at which a line drawn passing through the foregoing position at 0.25 mm intersects the outer contour of the dumbbell-shaped burr are the foregoing point A₁ and point A₃.

In addition, corresponding to the selection of the point A₂ in this step, the outermost side position of the dumbbell-shaped protrusion of the burr longitudinal section in the image of the ultra-depth-of-field microscope is selected, and the allowable deviation for the foregoing position selection is ±0.018 mm, thereby reducing the impact of human factors.

12. For the burr inspection method for a burr-shaped cast-in cylinder liner provided in the present application, the inspection method for the included angle α1 and the included angle α2 of the conical burr is:

Step S301. Find the positions of the conical burr that are 0.25 mm and 0.4 mm away from the top end according to step S101 to step S104. In this step, the measurement method that is the same as that in step S101 to step S104 is used to find the positions of the conical burr that are 0.25 mm and 0.4 mm away from the top end.

Step S302. Select the point A₁ and the point A₃ on the outer contour of the conical burr at the position of the burr that is 0.25 mm away from the top end in step S301, find the position of the burr that is 0.1 mm away from the top end on the image of the ultra-depth-of-field microscope in step S103 downward from the top end of the burr in the vertical direction, select the point A₂ on the outer contour of the burr longitudinal section on the image of the ultra-depth-of-field microscope at the position of the burr that is 0.1 mm away from the top end, and measure the included angle α2 between the extension of the connecting line A₁A₃ and the connecting line A₁A₂ through the software angle measurement function of the ultra-depth-of-field microscope. In this step, for the position selection of the point A₁ and the point A₃ on the outer contour of the conical burr, based on the position of the burr 0.25 mm away from the top end found in step S301 and by using the horizontal line marking function of the ultra-depth-of-field microscope device, points at which a line drawn passing through the foregoing position at 0.25 mm intersects the outer contour of the conical burr are the foregoing point A₁ and point A₃.

In addition, for the position selection of the point A₂ on the outer contour of the conical burr, based on the position of the burr 0.1 mm away from the top end found in step S301 and by using the horizontal line marking function of the ultra-depth-of-field microscope device, a point at which a line drawn passing through the foregoing position at 0.1 mm intersects the outer contour of the conical burr and that is close to the foregoing point A₁ is the foregoing point A₂.

### BRIEF DESCRIPTION OF THE DRAWINGS

To describe the technical solutions in specific embodiments of the present application or the prior art more clearly, the following briefly introduces the accompanying drawings required for describing the specific embodiments or the prior art. Apparently, the accompanying drawings in the following description show some embodiments of the present application, and a person of ordinary skill in the art may still derive other drawings from these accompanying drawings without creative efforts.

FIG. 1 is a schematic position diagram of specific parameters on a longitudinal section of a dumbbell-shaped burr according to the present application;

FIG. 2 is a schematic position diagram of a diameter L₁ and a diameter L₂ on a longitudinal section of a conical burr according to the present application;

FIG. 3 is a schematic position diagram of specific parameters on a longitudinal section of a conical burr according to the present application;

FIG. 4 is a cross-sectional view of a longitudinal section of a cylinder liner according to the present application;

FIG. 5 is a schematic position diagram of an inspection surface at an end position of a cylinder liner according to the present application; and

FIG. 6 is a schematic position diagram of liner outer diameter positions A for bonding ratio inspection at ends of a cylinder liner according to the present application.

### REFERENCE NUMERALS

1—cylinder liner; 2—outer circumferential surface; 3—dumbbell-shaped burr; 4—conical burr; and 5—inspection surface.

### DETAILED DESCRIPTION

The following clearly and completely describes the technical solutions in the present application with reference to the accompanying drawings. It is clear that the described embodiments are merely some rather than all of embodiments of the present application. All other embodiments obtained by persons of ordinary skill in the art based on embodiments of the present application without creative efforts shall fall within the scope of protection of the present application.

In the description of the present application, it needs to be understood that orientation or location relationships indicated by terms “center”, “upper”, “lower”, “left”, “right”, “vertical”, “horizontal”, “inside”, and “outside” are based on orientation or location relationships shown in the accompanying drawings, and are only used to facilitate description of the present application and simplify description, but are not used to indicate or imply that the apparatuses or elements must have specific orientations or are constructed and operated by using specific orientations, and therefore, cannot be understood as a limit to the present application. In addition, the terms “first”, “second”, and “third” are used only for description, but are not intended to indicate or imply relative importance.

### Embodiment 1

Refer to FIG. 1 and FIG. 4. FIG. 1 is a schematic position diagram of specific parameters on a longitudinal section of a dumbbell-shaped burr according to an embodiment of the present application. FIG. 4 is a cross-sectional view of a longitudinal section of a cylinder liner according to an embodiment of the present application.

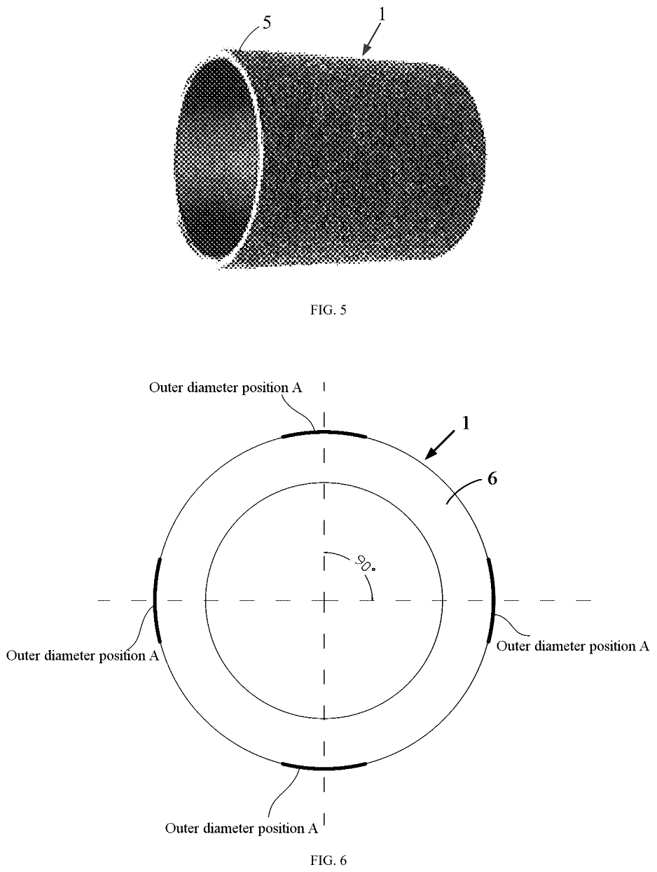

A burr-shaped cast-in cylinder liner is provided. As shown in FIG. 5, the cylinder liner 1 is made of cast iron and is cast into an engine block through a die casting process. A plurality of burrs are formed on an outer circumferential surface 2 of the cylinder liner 1. At least one of the burrs meets:
the burr includes a necked-shaped protrusion, and a position of the protrusion that is within an interval of 0.2 mm to 0.35 mm away from the top end of the burr is a necked structure. As shown in FIG. 1, the protrusion having the foregoing necked structure is a dumbbell-shaped burr 3.

A diameter of the dumbbell-shaped burr 3 in this embodiment at a position 0.25 mm away from the top end is L₁, a diameter of the burr at a position 0.4 mm away from the top end is L₂, and a range of a ratio of the diameter L₁ to the diameter L₂ is 0.65≤L₁:L₂≤1.15. Within the foregoing range of the ratio, the bonding ratio between a single burr and the engine block is high, thereby ensuring the bonding strength between the burr and the engine block.

For specific experimental data, refer to the following table:

| | Ratio of L₁:L₂ | Bonding ratio |
|---|---|---|
| Embodiment 1 | L₁:L₂ = 0.65 | 98.30% |
| Embodiment 2 | L₁:L₂ = 1.15 | 98.10% |
| Embodiment 3 | L₁:L₂ = 0.72 | 99.30% |
| Embodiment 4 | L₁:L₂ = 1.12 | 99.10% |
| Comparative | L₁:L₂ = 0.62 | 97.50% |
| embodiment 1 | | |
| Comparative | L₁:L₂ = 1.17 | 96.30% |
| embodiment 2 | | |

As can be learned from the foregoing table, in a preferred solution of the present application, when the range of the ratio of the diameter L₁ to the diameter L₂ is 0.65≤L₁:L₂≤1, the bonding ratio between the burr and the engine block is clearly higher than that when the range of the ratio L₁:L₂ of the diameter L₁ to the diameter L₂ is less than 0.65 or greater than 1.15. Related tools for obtaining the foregoing data are as follows: The cutting tool for cutting the cylinder liner 1 in the radial direction is a metal circular saw machine, model JC-130-NC, manufactured by Dongguan Jincheng Machinery Co., Ltd. The tool model of the ultra-depth-of-field microscope is Keyence VHX-2000 (Japan).

In addition, in this embodiment, to further improve the bonding strength between the cylinder liner 1 and the engine block and also ensure that the connection between the dumbbell-shaped burr 3 and the outer circumferential surface 2 of the cylinder liner 1 is secure and not prone to fracturing, as shown in FIG. 1:

a point A₁ and a point A₃ are provided on an outer contour of the dumbbell-shaped burr 3 at the position of the diameter L₁ of the dumbbell-shaped burr 3, a connecting line between the point A₁ and the point A₃ is the diameter L₁, a point A₂ is further provided at the apex of an outer contour of a dumbbell-shaped protrusion position of the dumbbell-shaped burr 3, the point A₂ and the point A₁ are located in the same longitudinal section of the dumbbell-shaped burr 3, a connecting line between the point A₁ and the point A₂ is a connecting line A₁A₂, the connecting line between the point A₁ and the point A₃ is a connecting line A₁A₃, and an included angle between an extension of the connecting line A₁A₃ and the connecting line A₁A₂ is α2; and the foregoing α2 defines the structure of the necked position of the dumbbell-shaped burr 3.

A point A₄ and a point A₅ are provided at the outer contour of the dumbbell-shaped burr 3 at the position of the diameter L₂ of the dumbbell-shaped burr 3, a connecting line between the point A₄ and the point A₅ is the diameter L₂, the point A₄ and the point A₁ are located in the same longitudinal section of the dumbbell-shaped burr 3, a connecting line between the point A₄ and the point A₁ is a connecting line A₄A₁, the connecting line between the point A₄ and the point A₅ is a connecting line A₄A₅, and an included angle between the connecting line A₄A₁ and the connecting line A₄A₅ is α1. When the value of the foregoing α1 is larger, the position of the outer circumferential surface 2 of the dumbbell-shaped burr 3 close to the cylinder liner 1, that is, the middle-to-lower position of the dumbbell-shaped burr 3, tends to flatten progressively. When the middle-to-lower position of the dumbbell-shaped burr 3 tends to flatten, the connecting surface between the dumbbell-shaped burr 3 and the outer circumferential surface 2 of the cylinder liner 1 is increased. The dumbbell-shaped burr 3 and the outer circumferential surface 2 of the cylinder liner 1 are securely connected and not prone to fracturing.

a range of a ratio of α1 to α2 is 2.1>α1:α2>0.5. When the foregoing α1 and α2 fall within the foregoing range of the ratio, the bonding ratio between a single burr and the engine block is high, the bonding strength between the cylinder liner 1 and the engine block is excellent, and the dumbbell-shaped burr 3 and the outer circumferential surface 2 of the cylinder liner 1 are securely connected.

For specific experimental data, refer to the following table:

| | Ratio of α1:α2 | Bonding ratio |
|---|---|---|
| Embodiment 1 | α1:α2 = 0.5 | 98.1% |
| Embodiment 2 | α1:α2 = 2.1 | 98.5% |
| Embodiment 3 | α1:α2 = 0.62 | 99.2% |
| Embodiment 4 | α1:α2 = 1.37 | 99.5% |
| Comparative | α1:α2 = 0.45 | 97.1% |
| embodiment 1 | | |
| Comparative | α1:α2 = 2.14 | 97.3% |
| embodiment 2 | | |

As can be learned from the foregoing table, in the preferred solution of the present application, when the ratio range of the ratio of the included angle α1 to the included angle α2 is 2.1>α1:α2>0.5, the bonding ratio between the burr and the engine block is clearly higher than that when the range of the ratio α1:α2 of the included angle α1 to the included angle α2 is less than 0.5 or greater than 2.1. Related tools for obtaining the foregoing data are as follows: The cutting tool for cutting the cylinder liner 1 in the radial direction is a metal circular saw machine, model JC-130-NC, manufactured by Dongguan Jincheng Machinery Co., Ltd. The tool model of the ultra-depth-of-field microscope is Keyence VHX-2000 (Japan).

In this embodiment, when the number of the dumbbell-shaped burrs 3 is suitable, the bonding ratios between a plurality of burrs on the cylinder liner 1 and the engine block can be ensured, thereby improving the bonding strength. On the cylinder liner 1, the number of the dumbbell-shaped burrs 3 within the range of 1 square centimeter ranges from 30 to 80.

In this embodiment, when the burr density of the dumbbell-shaped burrs 3 is suitable, the bonding ratios between a plurality of burrs on the cylinder liner 1 and the engine block can be ensured, thereby improving the bonding strength. The number of the dumbbell-shaped burrs 3 through which any 10-mm-long line segment of the outer circumferential surface 2 of the cylinder liner 1 with the dumbbell-shaped burrs 3 on the surface passes is 4 to 8.

An inspection method for the dumbbell-shaped burr 3 of a burr-shaped cast-in cylinder liner provided in the present application includes:
a method for inspecting the values of diameters of a burr at positions 0.25 mm and 0.4 mm away from the top end of the burr, including the following steps:
step S101. using an end position of a cylinder liner 1 or a vertical sectioned surface of the cylinder liner 1 in a radial direction as an inspection surface 5;
step S102. placing the inspection surface 5 of the cylinder liner 1 under an objective lens of an ultra-depth-of-field microscope;
step S103. rotating the coarse focus knob and the fine focus knob until the clear image is displayed on the computer screen;
step S104. finding the positions of the burr that are 0.25 mm and 0.4 mm away from the top end on the image in step S103 downward from the top end of the burr in a vertical direction, where the highest point of a burr longitudinal section is selected for the position of the burr away from the top end, and an allowable deviation for a distance of the burr that is away from the top end is ±0.018 mm; and
step S105. inspecting the value of an intercept L₁ of the position of the burr that is 0.25 mm away from the top end and the value of the intercept L₂ at the position of the burr that is 0.4 mm away from the top end in step S104, where the diameters of the burr at the positions 0.25 mm and 0.4 mm away from the top end are the horizontal direction lengths of the burr longitudinal section.

In addition, an inspection method for the included angle α1 and the included angle α2 of the dumbbell-shaped burr 3 is:
step S201. finding the positions of the dumbbell-shaped burr 3 that are 0.25 mm and 0.4 mm away from the top end according to step S101 to step S104; and
step S202. selecting the point A₁ and the point A₃ on the outer contour of the dumbbell-shaped burr 3 at the position of the burr that is 0.25 mm away from the top end in step S201, selecting the point A₂ at the apex of the outer contour of the dumbbell-shaped protrusion position of the dumbbell-shaped burr 3, where the point A₂ is the outermost side position of the dumbbell-shaped protrusion of the burr longitudinal section on the image of the ultra-depth-of-field microscope in step S103, and an allowable deviation for the outermost side position of the dumbbell-shaped protrusion is ±0.018 mm, measuring the included angle α2 between the extension of the connecting line A₁A₃ and the connecting line A₁A₂ through a software angle measurement function of the ultra-depth-of-field microscope,
selecting the point A₄ and the point A₅ on the outer contour of the dumbbell-shaped burr 3 at the position of the burr that is 0.4 mm away from the top end in step S201, and measuring the included angle α1 between the connecting line A₄A₁ and the connecting line A₄A₅ through the software angle measurement function of the ultra-depth-of-field microscope.

In this embodiment, a bonding ratio measurement method specifically includes the following steps:
step S1. die-casting a liner in an engine block, controlling a molten aluminum smelting temperature within a range of 700° C. to 720° C., and controlling a pouring temperature within a range of 650° C. to 680° C.; controlling a pre-heating temperature of the liner within 130° C. to 150° C., using a 28,000 KN die-casting machine, and setting a slow shot speed to 0.2 m/s and a fast shot speed to 5.5 m/s; and setting and maintaining a final pressure at 45 MPa;
step S2. cutting a circumferential section from the die-cast engine block at a position 25 mm to 35 mm away from a liner top end, and cutting a circumferential section from the die-cast engine block at a position 25 mm to 35 mm away from a liner bottom end; and
subsequently, grinding the foregoing annular end surfaces at the liner top end and the liner bottom end using sandpaper, sequentially with 180-grit, 400-grit, and 800-grit water sandpaper, and polishing the end surfaces on a polishing machine as required;
step S3. inspecting the bonding ratio between the aluminum engine block and the liner outer diameter for the liner top end and the liner bottom end of the ground and polished liner, where specific inspection positions are: as shown in FIG. 6, four liner outer diameter positions A with a perimeter of 10 mm at positions at 90-degree intervals of the liner outer diameter, and a specific inspection method is:
step S301. measuring a length of a pore with a perimeter below 10,000 μm along the surface of a burr through an ultra-depth-of-field microscope, where a gap between the aluminum engine block and the cast iron of the cylinder liner 1 observed through visual inspection under the microscope is a pore at the position; and the measured length of the gap is the length of the pore; and
step S302. calculating the foregoing bonding ratio between the aluminum engine block and the liner outer diameter by using a bonding ratio calculation formula: Bonding Ratio=(100−(ΣPorosity Length²/100,000,000))%, where the length of the pore is measured in μm.

Certainly, in this embodiment, the number of the dumbbell-shaped burrs 3 on the cylinder liner 1 is not specifically limited. In other embodiments, on the cylinder liner 1, the number of the dumbbell-shaped burrs 3 within the range of 1 square centimeter may alternatively be less than 30, or greater than 80.

Certainly, in this embodiment, the range of the ratio of α1 to α2 is also not specifically limited. In other embodiments, the range of the ratio of α1 to α2 may alternatively be α1:α2≤0.5, or the range of the ratio of α1 to α2 may alternatively be α1:α2≥2.1.

Certainly, in this embodiment, the number of the dumbbell-shaped burrs 3 through which any 10-mm-long line segment of the outer circumferential surface 2 of the cylinder liner 1 passes is not specifically limited. In other embodiments, the number of the dumbbell-shaped burrs 3 through which any 10-mm-long line segment of the outer circumferential surface 2 of the cylinder liner 1 with the dumbbell-shaped burrs 3 on the surface passes may alternatively be less than 4 or greater than 8.

Certainly, in this embodiment, a specific manner of casting the cylinder liner 1 into the engine block is not specifically limited. In other embodiments, the cylinder liner 1 is made of cast iron, and is cast into the engine block through a gravity casting process.

### Embodiment 2

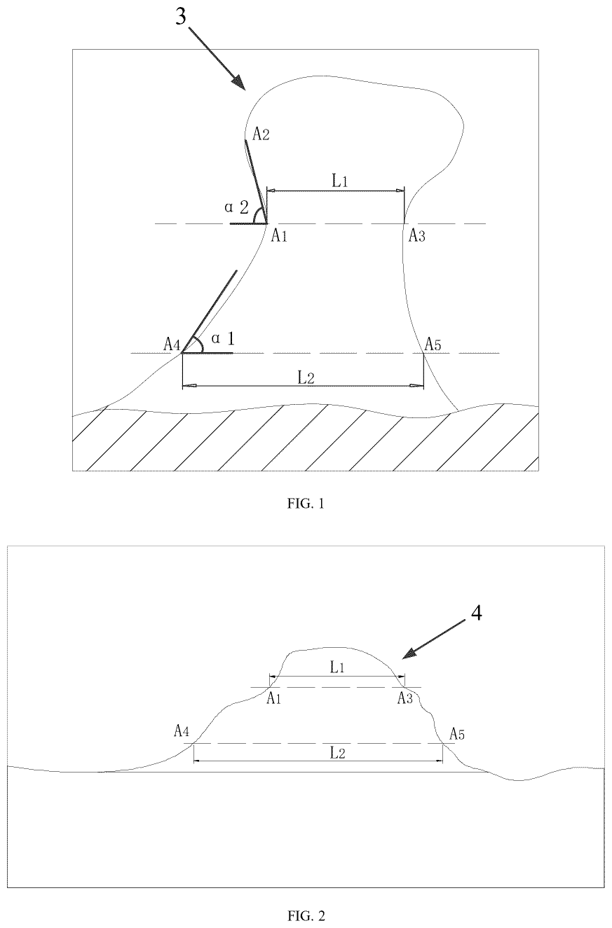

Refer to FIG. 2 and FIG. 4. FIG. 2 is a schematic position diagram of a diameter L₁ and a diameter L₂ on a longitudinal section of a conical burr according to an embodiment of the present application. FIG. 4 is a cross-sectional view of a longitudinal section of a cylinder liner according to an embodiment of the present application.

A burr-shaped cast-in cylinder liner is provided. As shown in FIG. 5, the cylinder liner 1 is made of cast iron and is cast in an engine block through a die casting process. A plurality of burrs are formed on an outer circumferential surface 2 of the cylinder liner 1. At least one of the burrs meets:

The burr includes a tapered protrusion. The foregoing tapered protrusion is a conical burr 4.

A diameter of the burr at a position 0.25 mm away from the top end is L₁, a diameter of the burr at a position 0.4 mm away from the top end is L₂, and a range of a ratio of the diameter L₁ to the diameter L₂ is 0.65≤L₁:L₂≤1.15. Within the foregoing range of the ratio, the bonding ratio between a single burr and the engine block is high, thereby ensuring the bonding strength between the burr and the engine block.

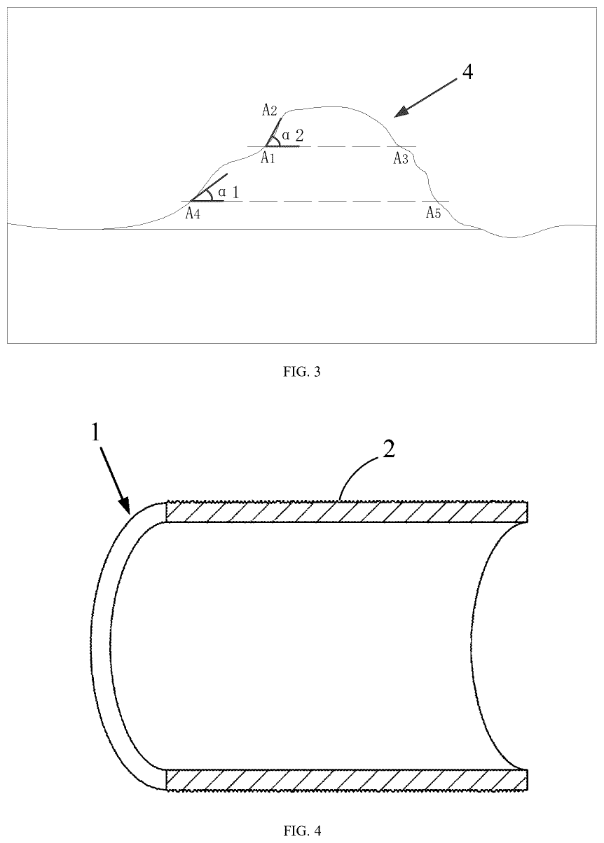

In addition, in this embodiment, to further improve the bonding strength between the cylinder liner 1 and the engine block and also ensure that the connection between the conical burr 4 and the outer circumferential surface 2 of the cylinder liner 1 is secure and not prone to fracturing. FIG. 3 is a schematic position diagram of specific parameters on a longitudinal section of a conical burr.

A point A₁ and a point A₃ are provided on an outer contour of the conical burr 4 at the position of the diameter L₁ of the conical burr 4, a connecting line between the point A₁ and the point A₃ is the diameter L₁, a point A₂ is further provided on the outer contour of the conical burr 4, the point A₂ is located at a position 0.1 mm away from the top end of the burr, the point A₂ and the point A₁ are located in the same longitudinal section of the conical burr 4, a connecting line between the point A₁ and the point A₂ is a connecting line A₁A₂, the connecting line between the point A₁ and the point A₃ is a connecting line A₁A₃, and an included angle between the connecting line A₁A₃ and the connecting line A₁A₂ is α2;
a point A₄ and a point A₅ are provided at the outer contour of the conical burr 4 at the position of the diameter L₂ of the conical burr 4, a connecting line between the point A₄ and the point A₅ is the diameter L₂, the point A₄ and the point A₁ are located in the same longitudinal section of the conical burr 4, a connecting line between the point A₄ and the point A₁ is a connecting line A₄A₁, the connecting line between the point A₄ and the point A₅ is a connecting line A₄A₅, and an included angle between the connecting line A₄A₁ and the connecting line A₄A₅ is α1; and
a range of a ratio of α1 to α2 is 1.0≥α1:α2≥0.25.

For specific experimental data, refer to the following table:

| | Ratio of α1:α2 | Bonding ratio |
|---|---|---|
| Embodiment 1 | α1:α2 = 0.25 | 98.2% |
| Embodiment 2 | α1:α2 = 1.0 | 98.5% |
| Embodiment 3 | α1:α2 = 0.3 | 99.2% |
| Embodiment 4 | α1:α2 = 0.9 | 99.6% |
| Comparative | α1:α2 = 0.21 | 97.1% |
| embodiment 1 | | |
| Comparative | α1:α2 = 1.03 | 96.6% |
| embodiment 2 | | |

As can be learned from the foregoing table, in the preferred solution of the present application, when the ratio range of the ratio of the included angle α1 to the included angle α2 is 1.0>α1:α2>0.25, the bonding ratio between the burr and the engine block is clearly higher than that when the range of the ratio α1:α2 of the included angle α1 to the included angle α2 is less than 0.25 or greater than 1.0. Related tools for obtaining the foregoing data are as follows: The cutting tool for cutting the cylinder liner 1 in the radial direction is a metal circular saw machine, model JC-130-NC, manufactured by Dongguan Jincheng Machinery Co., Ltd. The tool model of the ultra-depth-of-field microscope is Keyence VHX-2000 (Japan).

In this embodiment, when the number of the conical burrs 4 is suitable, the bonding ratios between a plurality of burrs on the cylinder liner 1 and the engine block can be ensured, thereby improving the bonding strength. On the cylinder liner 1, the number of the conical burrs 4 within the range of 1 square centimeter ranges from 45 to 85.

In this embodiment, when the burr density of the conical burrs 4 is suitable, the bonding ratios between a plurality of burrs on the cylinder liner 1 and the engine block can be ensured, thereby improving the bonding strength. The number of the conical burrs 4 through which any 10-mm-long line segment of the outer circumferential surface 2 of the cylinder liner 1 with the conical burrs 4 on the surface passes is 6 to 11.

A burr inspection method for a burr-shaped cast-in cylinder liner includes:
a method for inspecting the values of diameters of a conical burr 4 at positions 0.25 mm and 0.4 mm away from the top end of the burr, including the following steps:
step S101. using an end position of a cylinder liner 1 or a vertical sectioned surface of the cylinder liner 1 in a radial direction as an inspection surface 5;
step S102. placing the inspection surface 5 of the cylinder liner 1 under an objective lens of an ultra-depth-of-field microscope;
step S103. rotating the coarse focus knob and the fine focus knob until the clear image is displayed on the computer screen;
step S104. finding the positions of the burr that are 0.25 mm and 0.4 mm away from the top end on the image in step S103 downward from the top end of the burr in a vertical direction, where the highest point of a burr longitudinal section is selected for the position of the burr away from the top end, and an allowable deviation for a distance of the burr that is away from the top end is ±0.018 mm; and
step S105. inspecting the value of an intercept L₁ of the position of the burr that is 0.25 mm away from the top end and the value of the intercept L₂ at the position of the burr that is 0.4 mm away from the top end in step S104, where the diameters of the burr at the positions 0.25 mm and 0.4 mm away from the top end are the horizontal direction lengths of the burr longitudinal section.
an inspection method for the included angle α1 and the included angle α2 of the conical burr 4 is:
step S301. finding the positions of the conical burr 4 that are 0.25 mm and 0.4 mm away from the top end according to step S101 to step S104; and step S302. selecting the point A₁ and the point A₃ on the outer contour of the conical burr 4 at the position of the burr that is 0.25 mm away from the top end in step S301, finding a position of the burr that is 0.1 mm away from the top end on the image of the ultra-depth-of-field microscope in step S103 downward from the top end of the burr in the vertical direction, selecting the point A₂ on the outer contour of the burr longitudinal section on the image of the ultra-depth-of-field microscope at the position of the burr that is 0.1 mm away from the top end, measuring the included angle α2 between the extension of the connecting line A₁A₃ and the connecting line A₁A₂ through a software angle measurement function of the ultra-depth-of-field microscope,
selecting the point A₄ and the point A₅ on the outer contour of the conical burr 4 at the position of the burr that is 0.4 mm away from the top end in step S301, and measuring the included angle α1 between the connecting line A₄A₁ and the connecting line A₄A₅ through the software angle measurement function of the ultra-depth-of-field microscope.

In this embodiment, a bonding ratio measurement method specifically includes the following steps:
step S1. die-casting a liner in an engine block, controlling a molten aluminum smelting temperature within a range of 700° C. to 720° C., and controlling a pouring temperature within a range of 650° C. to 680° C.; controlling a pre-heating temperature of the liner within 130° C. to 150° C., using a 28,000 KN die-casting machine, and setting a slow shot speed to 0.2 m/s and a fast shot speed to 5.5 m/s; and setting and maintaining a final pressure at 45 MPa;
step S2. cutting a circumferential section from the die-cast engine block at a position 25 mm to 35 mm away from a liner top end, and cutting a circumferential section from the die-cast engine block at a position 25 mm to 35 mm away from a liner bottom end; and
subsequently, grinding the foregoing annular end surfaces at the liner top end and the liner bottom end using sandpaper, sequentially with 180-grit, 400-grit, and 800-grit water sandpaper, and polishing the end surfaces on a polishing machine as required;
step S3. inspecting the bonding ratio between the aluminum engine block and the liner outer diameter for the liner top end and the liner bottom end of the ground and polished liner, where specific inspection positions are: as shown in FIG. 6, four liner outer diameter positions A with a perimeter of 10 mm at positions at 90-degree intervals of the liner outer diameter, and a specific inspection method is:
step S301. measuring a length of a pore with a perimeter below 10,000 μm along the surface of a burr through an ultra-depth-of-field microscope, where a gap between the aluminum engine block and the cast iron of the cylinder liner 1 observed through visual inspection under the microscope is a pore at the position; and the measured length of the gap is the length of the pore; and
step S302. calculating the foregoing bonding ratio between the aluminum engine block and the liner outer diameter by using a bonding ratio calculation formula: Bonding Ratio=(100−(ΣPorosity Length²/100,000,000))%, where the length of the pore is measured in μm.

Certainly, in this embodiment, the range of the ratio of α1 to α2 is also not specifically limited. In other embodiments, the range of the ratio of α1 to α2 may alternatively be α1:α2<0.25 or α1:α2>1.0.

Certainly, in this embodiment, the number of the conical burrs 4 on the cylinder liner 1 is not specifically limited. In other embodiments, on the cylinder liner 1, the number of the conical burrs 4 within the range of 1 square centimeter may alternatively be less than 45, or greater than 85.

Certainly, in this embodiment, the number of the conical burrs 4 through which any 10-mm-long line segment of the outer circumferential surface 2 of the cylinder liner 1 passes is not specifically limited. In other embodiments, the number of the conical burrs 4 through which any 10-mm-long line segment of the outer circumferential surface 2 of the cylinder liner 1 with the dumbbell-shaped burrs 3 on the surface passes may alternatively be less than 6 or greater than 11.

Certainly, in this embodiment, a specific manner of casting the cylinder liner 1 into the engine block is not specifically limited. In other embodiments, the cylinder liner 1 is made of cast iron, and is cast into the engine block through a gravity casting process.

Clearly, the foregoing embodiments are merely examples for clear description, rather than a limitation to implementations. For a person of ordinary skill in the art, other changes or variations in different forms may also be made based on the foregoing description. All implementations cannot and do not need to be exhaustively listed herein. Obvious changes or variations that are derived there from still fall within the scope of protection of the invention of the present application.

What is claimed is:

1. A burr-shaped cast-in cylinder liner, the cylinder liner being made of cast iron and being cast into an engine block through a die casting or gravity casting process, and a plurality of burrs being formed on an outer circumferential surface of the cylinder liner, wherein at least one of the burrs satisfies:
a diameter of the burr at a position 0.25 mm away from the top end is L₁, a diameter of the burr at a position 0.4 mm away from the top end is L₂, and a range of a ratio of the diameter L₁ to the diameter L₂ is 0.65≤L₁:L₂≤1.15, wherein
the burr comprises a necked-shaped protrusion, and a position of the protrusion that is within an interval of 0.2 mm to 0.35 mm away from the top end of the burr is a necked structure; or the burr comprises a tapered protrusion.

2. The burr-shaped cast-in cylinder liner according to claim 1, wherein the necked-shaped protrusion is a dumbbell-shaped burr;
a point A₁ and a point A₃ are provided on an outer contour of the dumbbell-shaped burr at the position of the diameter L₁ of the dumbbell-shaped burr, a connecting line between the point A₁ and the point A₃ is the diameter L₁, a point A₂ is further provided at the apex of an outer contour of a dumbbell-shaped protrusion position of the dumbbell-shaped burr, the point A₂ and the point At are located in the same longitudinal section of the dumbbell-shaped burr, a connecting line between the point A₁ and the point A₂ is a connecting line A₁A₂, the connecting line between the point A₁ and the point A₃ is a connecting line A₁A₃, and an included angle between an extension of the connecting line A₁A₃ and the connecting line A₁A₂ is α2;
a point A₄ and a point A₅ are provided at the outer contour of the dumbbell-shaped burr at the position of the diameter L₂ of the dumbbell-shaped burr, a connecting line between the point A₄ and the point A₅ is the diameter L₂, the point A₄ and the point A₁ are located in the same longitudinal section of the dumbbell-shaped burr, a connecting line between the point A₄ and the point A₁ is a connecting line A₄A₁, the connecting line between the point A₄ and the point A₅ is a connecting line A₄A₅, and an included angle between the connecting line A₄A₁ and the connecting line A₄A₅ is α1; and
a range of a ratio of α1 to α2 is α1:α2≥0.5.

3. The burr-shaped cast-in cylinder liner according to claim 2, wherein the range of the ratio of α1 to α2 is α1:α2≤2.1.

4. The burr-shaped cast-in cylinder liner according to claim 2, wherein on the cylinder liner, the number of the dumbbell-shaped burrs within the range of 1 square centimeter ranges from 30 to 80.

5. The burr-shaped cast-in cylinder liner according to claim 2, wherein the number of the dumbbell-shaped burrs through which any 10-mm-long line segment of the outer circumferential surface of the cylinder liner passes is 4 to 8.

6. The burr-shaped cast-in cylinder liner according to claim 1, wherein the tapered protrusion is a conical burr;
a point A₁ and a point A₃ are provided on an outer contour of the conical burr at the position of the diameter L₁ of the conical burr, a connecting line between the point A₁ and the point A₃ is the diameter L₁, a point A₂ is further provided on the outer contour of the conical burr, the point A₂ is located at a position 0.1 mm away from the top end of the burr, the point A₂ and the point At are located in the same longitudinal section of the conical burr, a connecting line between the point A₁ and the point A₂ is a connecting line A₁A₂, the connecting line between the point A₁ and the point A₃ is a connecting line A₁A₃, and an included angle between the connecting line A₁A₃ and the connecting line A₁A₂ is α2;
a point A₄ and a point A₅ are provided at the outer contour of the conical burr at the position of the diameter L₂ of the conical burr, a connecting line between the point A₄ and the point A₅ is the diameter L₂, the point A₄ and the point A₁ are located in the same longitudinal section of the conical burr, a connecting line between the point A₄ and the point A₁ is a connecting line A₄A₁, the connecting line between the point A₄ and the point As is a connecting line A₄A₅, and an included angle between the connecting line A₄A₁ and the connecting line A₄A₅ is α1; and
a range of a ratio of α1 to α2 is α1:α2≥0.25.

7. The burr-shaped cast-in cylinder liner according to claim 6, wherein the range of the ratio of α1 to α2 is α1:α2≤1.0.

8. The burr-shaped cast-in cylinder liner according to claim 6, wherein
on the cylinder liner, the number of the conical burrs within the range of 1 square centimeter ranges from 45 to 85.

9. The burr-shaped cast-in cylinder liner according to claim 6, wherein the number of the conical burrs through which any 10-mm-long line segment of the outer circumferential surface of the cylinder liner passes is 6 to 11.

10. A burr inspection method for a burr-shaped cast-in cylinder liner, comprising:
a method for inspecting the values of diameters of a burr at positions 0.25 mm and 0.4 mm away from the top end of the burr, comprising the following steps:
step S101. using an end position of a cylinder liner or a vertical sectioned surface of the cylinder liner in a radial direction as an inspection surface;
step S102. placing the inspection surface of the cylinder liner under an objective lens of an ultra-depth-of-field microscope;
step S103. rotating a coarse focus knob and a fine focus knob until a clear image is displayed on a computer screen;
step S104. finding the positions of the burr that are 0.25 mm and 0.4 mm away from the top end on the image in step S103 downward from the top end of the burr in a vertical direction, wherein the highest point of a burr longitudinal section is selected for the position of the burr away from the top end, and an allowable deviation for a distance of the burr that is away from the top end is ±0.018 mm; and
step S105. inspecting the value of an intercept L₁ of the position of the burr that is 0.25 mm away from the top end and the value of an intercept L₂ at the position of the burr that is 0.4 mm away from the top end in step S104, wherein the diameters of the burr at the positions 0.25 mm and 0.4 mm away from the top end are horizontal direction lengths of the burr longitudinal section.

11. The burr inspection method for a burr-shaped cast-in cylinder liner according to claim 10, wherein the burr inspection method is applied to the burr-shaped cast-in cylinder liner of claim 1.

12. The burr inspection method for a burr-shaped cast-in cylinder liner according to claim 10, wherein the burr inspection method is applied to the burr-shaped cast-in cylinder liner of claim 2; and
an inspection method for the included angle α1 and the included angle α2 of the dumbbell-shaped burr is:
step S201. finding the positions of the dumbbell-shaped burr that are 0.25 mm and 0.4 mm away from the top end according to step S101 to step S104; and
step S202. selecting the point A₁ and the point A₃ on the outer contour of the dumbbell-shaped burr at the position of the burr that is 0.25 mm away from the top end in step S201, selecting the point A₂ at the apex of the outer contour of the dumbbell-shaped protrusion position of the dumbbell-shaped burr, wherein the point A₂ is the outermost side position of the dumbbell-shaped protrusion of the burr longitudinal section on the image of the ultra-depth-of-field microscope in step S103, and an allowable deviation for the outermost side position of the dumbbell-shaped protrusion is ±0.018 mm, measuring the included angle α2 between the extension of the connecting line A₁A₃ and the connecting line A₁A₂ through a software angle measurement function of the ultra-depth-of-field microscope,
selecting the point A₄ and the point A₅ on the outer contour of the dumbbell-shaped burr at the position of the burr that is 0.4 mm away from the top end in step S201, and measuring the included angle α1 between the connecting line A₄A₁ and the connecting line A₄A₅ through the software angle measurement function of the ultra-depth-of-field microscope.

13. The burr inspection method for a burr-shaped cast-in cylinder liner according to claim 10, wherein the burr inspection method is applied to the burr-shaped cast-in cylinder liner of claim 6; and
an inspection method for the included angle α1 and the included angle α2 of the conical burr is:
step S301. finding the positions of the conical burr that are 0.25 mm and 0.4 mm away from the top end according to step S101 to step S104; and
step S302. selecting the point A₁ and the point A₃ on the outer contour of the conical burr at the position of the burr that is 0.25 mm away from the top end in step S301, finding a position of the burr that is 0.1 mm away from the top end on the image of the ultra-depth-of-field microscope in step S103 downward from the top end of the burr in the vertical direction, selecting the point A₂ on the outer contour of the burr longitudinal section on the image of the ultra-depth-of-field microscope at the position of the burr that is 0.1 mm away from the top end, measuring the included angle α2 between the extension of the connecting line A₁A₃ and the connecting line A₁A₂ through a software angle measurement function of the ultra-depth-of-field microscope,
selecting the point A₄ and the point A₅ on the outer contour of the conical burr at the position of the burr that is 0.4 mm away from the top end in step S301, and measuring the included angle α1 between the connecting line A₄A₁ and the connecting line A₄A₅ through the software angle measurement function of the ultra-depth-of-field microscope.

14. The burr inspection method for a burr-shaped cast-in cylinder liner according to claim 10, wherein the burr inspection method for a burr-shaped cast-in cylinder liner is used to inspect L₁ and L₂ of the burr-shaped cast-in cylinder liner of claim 1.

15. The burr-shaped cast-in cylinder liner according to claim 3, wherein on the cylinder liner, the number of the dumbbell-shaped burrs within the range of 1 square centimeter ranges from 30 to 80.

16. The burr-shaped cast-in cylinder liner according to claim 3, wherein the number of the dumbbell-shaped burrs through which any 10-mm-long line segment of the outer circumferential surface of the cylinder liner passes is 4 to 8.

17. The burr-shaped cast-in cylinder liner according to claim 7, wherein
on the cylinder liner, the number of the conical burrs within the range of 1 square centimeter ranges from 45 to 85.

18. The burr-shaped cast-in cylinder liner according to claim 7, wherein the number of the conical burrs through which any 10-mm-long line segment of the outer circumferential surface of the cylinder liner passes is 6 to 11.
